(19) United States
(12) Patent Application Publication
(10) Pub. No.: US 2015/0199379 A1
(43) Pub. Date: Jul. 16, 2015

(54) SORTING AND SEARCHING OF RELATED CONTENT BASED ON UNDERLYING FILE METADATA

(71) Applicant: GOOGLE INC., (US)

(72) Inventors: Tobias Thierer, Glebe NSW (AU); Anil Sabharwal, Pymble NSW (AU)

(73) Assignee: GOOGLE INC., Mountain View, CA (US)

(21) Appl. No.: 13/664,018

(22) Filed: Oct. 30, 2012

(51) Int. Cl. G06F 17/30

(52) U.S. Cl. CPC G06F 17/30241; G06F 17/30864; G06F 17/30525; G06F 17/30106

(57) ABSTRACT

A method for searching for similar files stored on a server includes determining a target geolocation for a target file stored on the server, where the target geolocation is based on a geographical location of a client device on which a user has edited the target file, and storing the target geolocation in metadata of the target file. The method further includes receiving from the user a request to search a plurality of files stored on the server based on similarity to the target file, where the similarity is based on the target geolocation and a plurality of attributes of the target file, assigning a score to each file in the plurality of files, where the score is based on the similarity of each file to the target geolocation and the plurality of attributes, and presenting to the user a list of the plurality of files ordered by score.

### BACKGROUND

Cloud storage systems provide users with the ability to store electronic documents and other files on a remote network rather than on a local computer. This allows users the ability to access the remotely stored files from any device that is capable of connecting with the remote network, for example using a web browser over an Internet connection. Users typically log into an account on the cloud storage system using a username and password. The cloud storage system provides a user interface for users to view, edit, and manage files stored on the system. Cloud storage systems also provide users the ability to share files with other users and to allow collaboration between users on the same file.

Electronic files stored in computing devices and systems, such as a client computer or a cloud storage system, include both content data and metadata. Content data encodes the content of the file, such as text and formatting information for word processing documents, sound data for music files, image data for image files, and image and sound data for video files. Metadata contains information or attributes about the file itself, for example the name of the file, the owner or creator of the file, the date the file was created, the date the file was last modified, and the identity of collaborators of the file. Users on a cloud storage system are able to view or search the metadata of the electronic file, and may sort multiple files based on the metadata. File metadata may contain any number of fields related to the file that may be useful for sorting the file and searching for the file. Users may also be able to find similar files to a target file based on the content of the file, for example by comparing the frequency or prominence of keywords within the files.

Because users may connect to the cloud storage system from any device capable of connecting to the Internet, users may create and edit files from a number of locations, such as from the home, the office, a particular transit route, or from a number of cities around the world. Thus in a cloud storage system electronically determined geographical location information, or geolocation information, about files may be useful for sorting and searching for similar files. For example, a user may wish to search for files similar to a target file, where the target file was created at home during a particular week and last edited at the office during a subsequent week. Currently, cloud storage systems do not store any geolocation information for files stored on their systems and so could not perform the search described above.

### SUMMARY

Thus there exists a need in the art to provide systems and methods for sorting and searching of related content based on underlying file metadata, where the metadata includes geolocation. A cloud storage system includes one or more servers for storing files for a user. Each file includes metadata that stores geolocation information, such as the location that the file was created or the location that the file was last modified. The geolocation is obtained from the client device on which the user accesses the file. For example, the IP address of the client device or the Wi-Fi network that the client device is using may be used to obtain geolocation information. Global positioning system (GPS) capabilities may also be used to locate the client device if the client device is enabled to use GPS. The cloud storage system provides a user interface for the user to search for files similar to a target file based on a number of attributes, where geolocation is one of the attributes. The cloud storage system presents a list of similar files to the user, where the list is ordered by similarity to the attributes.

One aspect described herein discloses a method for searching for similar files stored on a server. The method includes determining, at the server, a target geolocation for a target file stored on the server, where the target geolocation is based on a geographical location of a client device on which a user has edited the target file, and storing the target geolocation of the target file in metadata of the target file. The method further includes receiving from the user a request to search a plurality of files stored on the server based on similarity to the target file, where the similarity is based on the target geolocation and a plurality of attributes of the target file, assigning a score to each file in the plurality of files, where the score is based on the similarity of each file to the target geolocation and the plurality of attributes, and presenting to the user a list of the plurality of files ordered by score.

Another aspect described herein discloses a method for attribute-matching search of files stored on a server. The method includes determining, at the server, a target geolocation for a target file stored on the server, where the target geolocation is based on a geographical location of a client device on which a user has edited the target file, and storing the target geolocation of the target file in metadata of the target file. The method further includes receiving from the user a request to search a plurality of files stored on the server for files matching the target geolocation and a plurality of attributes of the target file, identifying a plurality of matching files from the plurality of files, where the geolocation of each matching file in the plurality of matching files is the same as the target geolocation and the plurality of attributes of each matching file is the same as the plurality of attributes of the target file, and presenting to the user a list of the plurality of matching files.

Another aspect described herein discloses a system for searching for similar files stored on a server, where the system includes a server. The server is configured to communicate with a client device using a communication connection, determine a target geolocation for a target file stored on the server, where the target geolocation is based on a geographical location of the client device on which a user has edited the target file, and store the target geolocation of the target file in metadata of the target file. The server is further configured to receive from the user a request to search a plurality of files stored on the server based on similarity to the target file, where the similarity is based on the target geolocation and a plurality of attributes of the target file, assign a score to each file in the plurality of files, where the score is based on the similarity of each file to the target geolocation and the plurality of attributes, and present to the user a list of the plurality of files ordered by score.

### BRIEF DESCRIPTION OF THE DRAWINGS

The methods and systems may be better understood from the following illustrative description with reference to the following drawings in which:

FIG. 1 shows a client-server system for sorting and searching of related content based on underlying file metadata in accordance with an implementation as described herein;

FIG. 2 shows a way of obtaining geolocation information of a client device in accordance with an implementation as described herein;

FIG. 3 shows another way of obtaining geolocation information of a client device in accordance with an implementation as described herein;

FIG. 4 shows another way of obtaining geolocation information of a client device in accordance with an implementation as described herein;

FIG. 5 shows the components of a server configured for sorting and searching of related content based on underlying file metadata in accordance with an implementation as described herein;

FIG. 6 shows the file structure of a data file in accordance with an implementation as described herein;

FIG. 7 shows a user interface for sorting and searching of related content based on underlying file metadata in accordance with an implementation as described herein;

FIG. 8 shows another user interface for sorting and searching of related content based on underlying file metadata in accordance with an implementation as described herein;

FIG. 9 shows a method for searching for similar files stored on a server in accordance with an implementation as described herein; and

FIG. 10 shows another method for an attribute-matching search of files stored on a server in accordance with an implementation as described herein.

### DETAILED DESCRIPTION

To provide an overall understanding of the systems and methods described herein, certain illustrative embodiments will now be described, including systems and methods for sorting and searching of related content based on underlying file metadata, where the metadata includes geolocation information. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. In particular, a server or system as used in this description may be a single computing device or multiple computing devices working collectively and in which the storage of data and the execution of functions are spread out amongst the various computing devices.

Aspects of the systems and methods described herein provide a cloud storage system capable of sorting and searching of related content based on underlying file metadata, where the metadata includes geolocation information. A cloud storage system includes one or more servers for storing files for a user. Each file includes metadata that stores geolocation information, such as the location that the file was created or the location that the file was last edited. The geolocation of a file is obtained from the client device on which the user accesses the file. For example, the IP address of the client device or the Wi-Fi network that the client device is using may be used to obtain geolocation information. Global positioning system (GPS) capabilities may also be used to locate the client device if the client device is enabled to use GPS. The cloud storage system provides a user interface for the user to search for files similar to a target file based on a number of attributes, where geolocation is one of the attributes. Other attributes may include the name of the file, date the file was created, the date the file was last edited, the owner or collaborators of the file, and the file contents. Each of the files searched is assigned a score based on the similarity to the attributes of each file to the target file. The cloud storage system presents a list of files to the user, where the list is ordered by score.

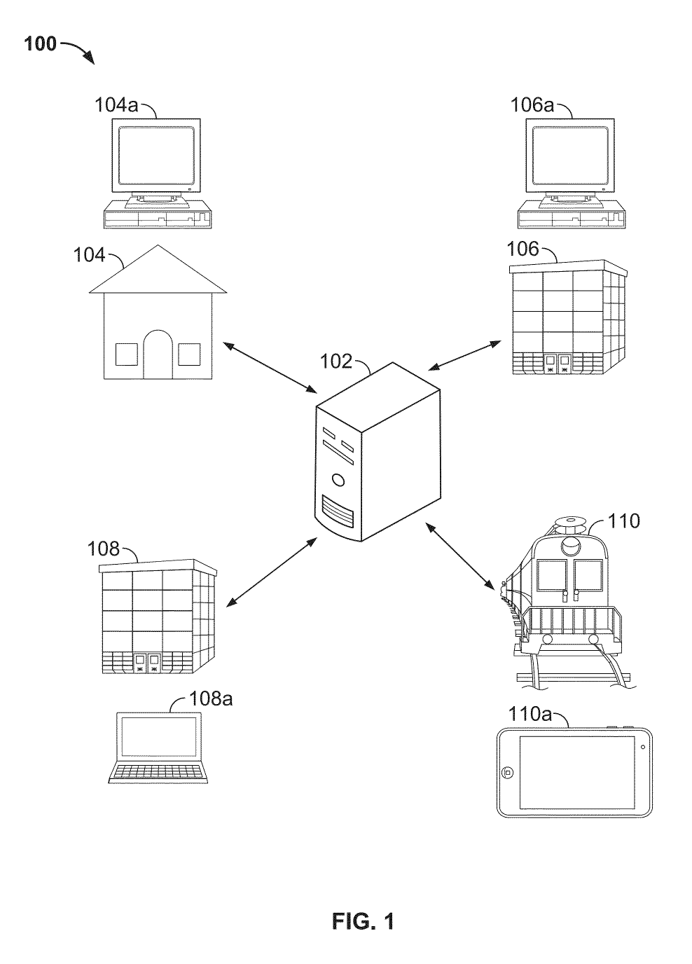

Many client devices are capable of connecting with remote networks, such as the Internet. Through such connections users are able to access online services such as a cloud storage system for creating, viewing, editing, storing, and sharing files. Cloud storage systems provide users with an account for storing files and allow the user to access the files from any client device. FIG. 1 shows an example of a cloud storage system providing services to a number of client devices. System 100 includes cloud storage system 102, which may include one or more servers or other computing devices that collectively provide the cloud storage service. For example, cloud storage system 102 may have multiple data servers for storing files for users of the services and one or more gateway servers configured to handle communications with client devices.

System 100 also includes a number of client devices such as desktop computer 104a located at residential home 104, a desktop computer 106a located at an office 106, laptop computer 108a located at a secondary office 108, and a tablet 110a or other mobile client device located on a train 110 or some other mode of transportation. Cloud storage system 102 may connect with any number of client devices located in a variety of different places through a remote network connection. The remote network connection may be a wired or wireless Internet connection, local area network (LAN), wide area network (WAN), Wi-Fi network, Ethernet, or any other type of known connection.

Users may access a cloud storage system from a variety of geographical locations, as illustrated in FIG. 1. The user may use different client devices located at different locations to access the cloud storage system, such as desktop computers 104a and 106a. The user may also carry a portable client device, such as laptop 108a and tablet 110a, between a number of locations, accessing the cloud storage system at any location where a remote network connection is possible. For a cloud storage system to store geolocation information about a file accessed by a user, the cloud storage system first determines the geolocation of the client device from which the user accessed the file.

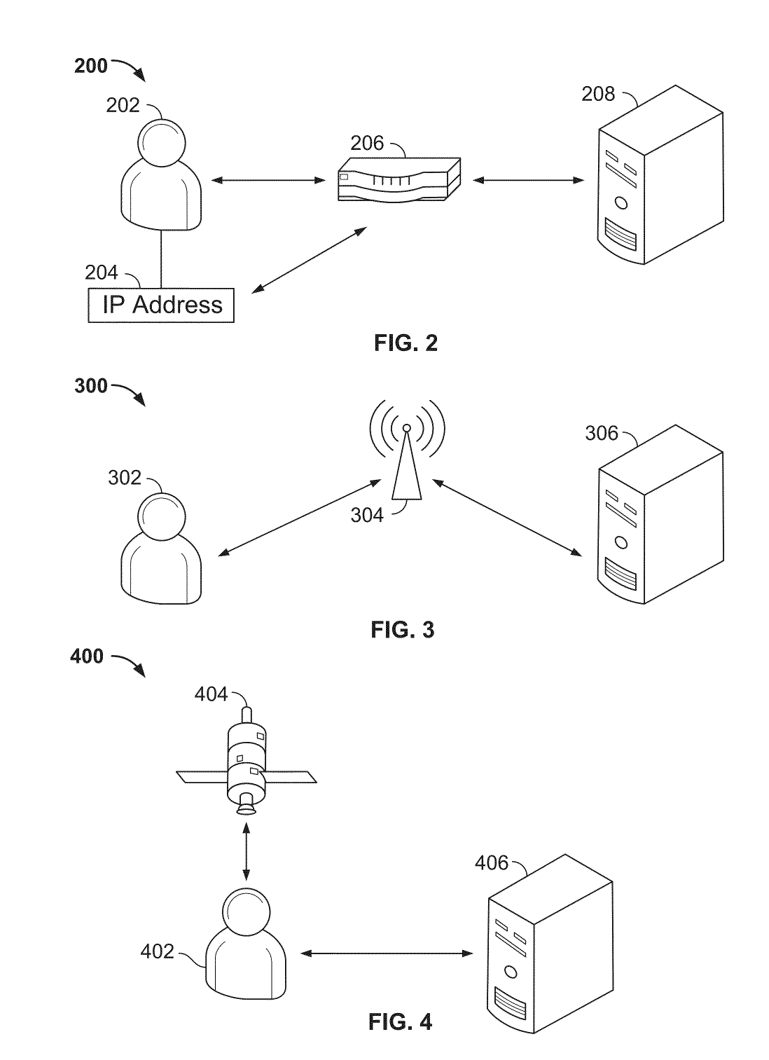

The geolocation of a client device may be determined in a number of ways. One way of determining the geolocation of a client device is through the IP address assigned to the client device when the client device connects to the Internet. FIG. 2 illustrates the use of IP addresses obtain geolocation information of a client device. System 200 shows a client device 202 connected to cloud storage system 208 through a router 206. Router 206 allows client device 202 to connect to the Internet and thus to connect to cloud storage system 208. Devices capable of connecting client device 202 to the Internet are not limited to routers, but may encompass any other devices capable of connecting a client device to the Internet. When client device 202 connects to the Internet through router 206, client device 202 is assigned an IP address 204 by router 206. The IP address for a client device remains the same during a single connection session, but each new session started by client device 202 may result in a new IP address 204 being assigned to client device 202.

IP addresses have a standard format which depends on the version of the Internet Protocol implemented by router 106, such as xxx.xx.xxx.x for the IPv4 standard where each ‘x’ is a single digit numerical value, or yyyy:yyyy:yyyy:yyyy for the IPv6 standard where each ‘y’ is a single hexadecimal value. Geolocation information may be determined from the value of the IP address. Large blocks of IPv4 addresses have been allocated to corporations or regional Network Information Centers, which then further allocate them within their geographical scope. For example, all IPv4 addresses whose first byte has the value 41 are allocated via AfriNIC, which is responsible for allocating these addresses within Africa. Publicly available databases may be used to further refine the geolocation of an IP address down to a zip code/postal code or city or suburb level. Cloud storage system 208 receives IP address 204 from client device 202 and may use these IP address databases to determine the geolocation of client device 202 down to a specific level. However, geolocation using IP addresses usually cannot be refined further than city or suburb level.

Another way of determining the geolocation of a client device is through identification of the geolocation of a Wi-Fi network that a client devices uses to access the Internet. This situation is illustrated in FIG. 3. System 300 shows a client device 302 connected to cloud storage system 306 through Wi-Fi network 304. Client device 302 is enabled to connect to Wi-Fi networks. Each Wi-Fi network has a unique media access control (MAC) address. Proprietary databases compile Wi-Fi MAC addresses and corresponding geographical locations for those addresses. Cloud storage system 306 obtains the MAC address of Wi-Fi network 304 and uses the Wi-Fi geolocation databases to determine the location of client device 302. Wi-Fi networks cover a limited range of area, for example over a neighborhood or building. Thus geolocation using Wi-Fi networks gives greater location specificity than geolocation using IP addresses.

Yet another way of determining the geolocation of a client device is by utilizing the GPS functionality on a client device, assuming that the client device has such functionality. This situation is illustrated in FIG. 4. System 400 includes a client device 402 that connects to cloud storage system 406 through any standard network connection. Client device 402 is capable of GPS functionality and communicates with satellites 404 to obtain GPS information about the location of client device 402. Client device 402 passes along the GPS information to cloud storage system 406. GPS geolocation information may include the latitude and longitude of the client device, and the elevation of the client device. Thus geolocation using GPS gives greater location specificity than geolocation using Wi-Fi network locations or IP addresses.

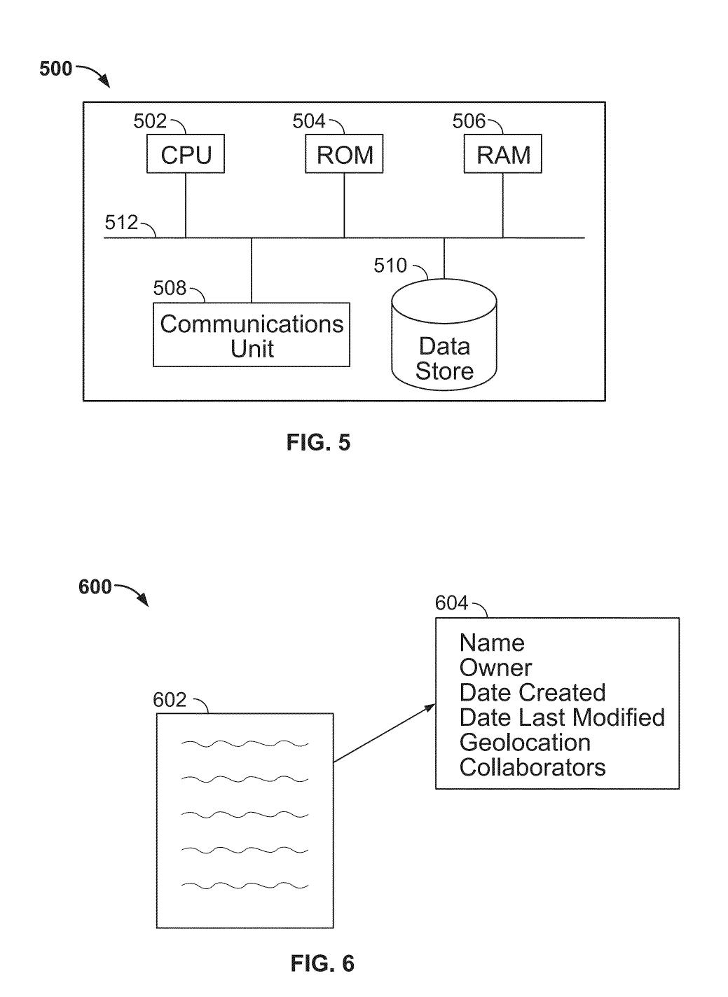

A cloud storage system that receives geolocation information from a client device may save this information in the metadata of files that a user on the client device accesses. First, a general cloud storage system capable of storing geolocation metadata and providing searching and sorting of files based on similarity of geolocation and other attributes is described in more detail. Server 500 in FIG. 5 shows an example of a server for use in a cloud storage system. A cloud storage system may include a number of servers that collectively provide the cloud storage service. Server 500 includes a central processing unit (CPU) 502, read only memory (ROM) 504, random access memory (RAM) 506, communications unit 508, data store 510, and bus 512. Server 500 may have additional components that are not illustrated in FIG. 5. Bus 512 allows the various components of server 500 to communicate with each other. Communications unit 508 allows the server 500 to communicate with other devices, such as client devices or other servers in the cloud storage system. Data store 510 may store, among other things, data files belonging to users of the cloud storage system. Data store 510 may also store a geolocation database for mapping IP addresses or Wi-Fi network MAC addresses to specific locations. Users connect with server 500 through communications unit 508 to access files stored in data store 510.

Data store 510 for providing cloud storage services may be implemented using non-transitory computer-readable media. In addition, other programs executing on server 500 may be stored on non-transitory computer-readable media. Examples of suitable non-transitory computer-readable media include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

A cloud storage system stores a large number of files for a number of users. Files stored on a cloud storage system may include word processing documents, spreadsheets, presentations, pictures, music, videos, and a variety of other file formats. A user may use any client device to log into a cloud storage system using a username and password or other login mechanism and access data files owned by the user. The user may upload, download, edit, or share these files with other users using the cloud storage system. FIG. 6 illustrates the file structure for files stored in a cloud storage system. File 600 includes content data 602 for encoding the content of the file and metadata 604 for storing information related to the file. Information stored in metadata 604 may include the name of the file, its owner or creator, the date it was created, the date it was last modified, and a list of collaborators. Metadata 604 may also include geolocation information, including a geolocation associated with the creation date and a geolocation associated with the last modified date. Metadata may also store the geolocation of each date that the file was edited and the user who edited the file. Other information relating to the file not specifically mentioned herein may also be stored in metadata 404.

Geolocation information is obtained from the client device using any of the methods described above. The specificity of the geolocation information depends on whether the client device is connected to the cloud storage system using a Wi-Fi network or whether the client device has GPS functionality. The cloud storage system may request the user of the client device for permission before obtaining geolocation information through either the Wi-Fi network or GPS. The cloud storage system may also allow the user to label geolocation information. For example, if the cloud storage system recognizes that the user regularly connects to the cloud storage system using IP addresses from a particular geolocation, the cloud storage system may ask the user to give the geolocation a label, such as “Home,” “Office,” or “Boston.” If the geolocation information is based on Wi-Fi network or GPS information, the label may be more specific. The cloud storage system associates these labels with the geolocation information stored in metadata 604, and allows a user to search or sort files using the labels.

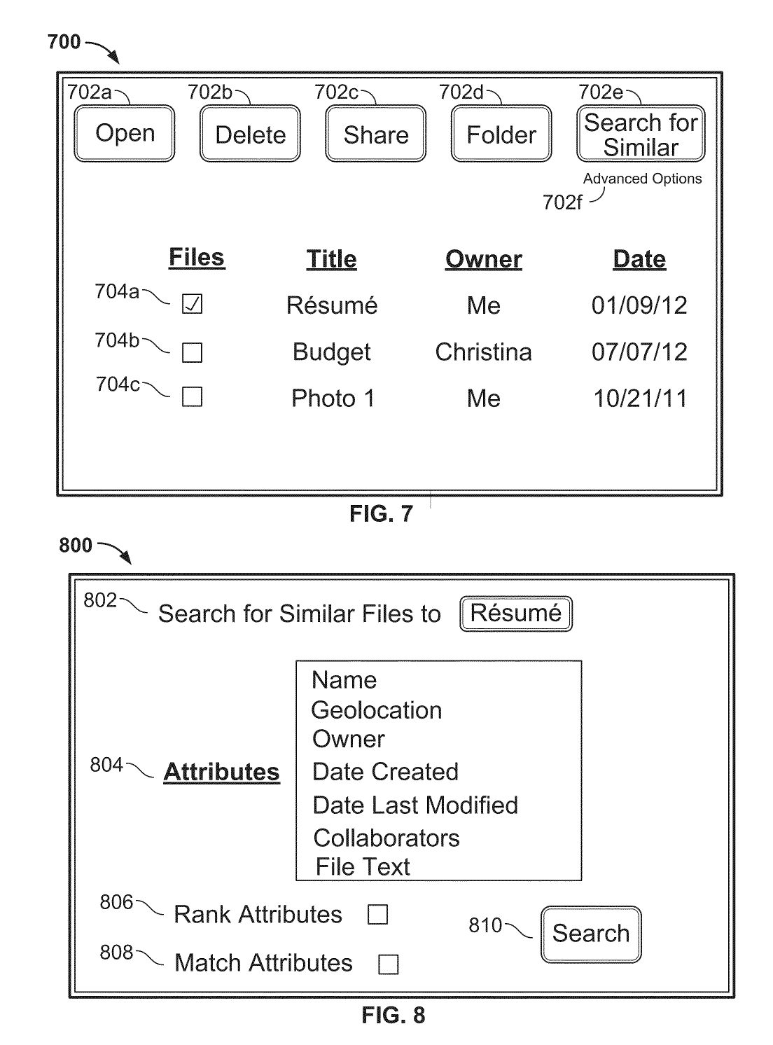

A cloud storage system provides users with a user interface for viewing and organizing files the users have stored in the cloud storage system. FIG. 7 illustrates an example of a user interface for displaying files that a user has stored in a cloud storage database. The user interface may be displayed in a web browser on a client device. User interface 700 includes a list of files 704a through 704c stored in the cloud storage system that are owned by the user or perhaps also shared with the user by another person. The listing of files includes the name of each file, the owner of the file, and the time it was last modified. This information is obtained from the metadata of the file. Other information relating to the files may be displayed in the user interface. Files listed in user interface 700 may have a checkbox or other selection indicator beside the files for the user to select files to perform commands on. User interface 700 has a number of command buttons 702a through 702e that a user may apply to the files listed in the user interface. For example, the command buttons may include “open” button 702a for opening a file, “delete” button 702b for deleting a file, “share” button 702c for sharing a button with one or more recipients, “folder” button 702d for sorting files into folders, and “search for similar” button 702e for searching for files similar to a selected file. User interface 700 may include any number of other commands not illustrated in FIG. 7.

The “search for similar” button 702e invokes a function to search for files similar to a selected file. The files searched may include files owned by the user but may also include files shared with the user. In FIG. 7, the selected file, or target file, is “Résumé.” When “search for similar” button 702e is selected, the cloud storage system determines a set of attributes of the target file to be used to find similar files. There may be a default set of attributes that the cloud storage system uses, which the user may modify using the “Advanced Options” link 702f, which will be described in more detail in relation to FIG. 8. The default set of attributes is drawn from the metadata and/or the content data of the target file. The default set of attributes includes geolocation information of the target file, as well as other attributes. The attributes that may be searched for similarity may include name of the file, the date it was created, the date it was last modified, the geolocation of when it was created or last modified, the list of collaborators, priority designations, and any other searchable attributes stored in the metadata or file content. For example, the default set of attributes may be owner, geolocation, date created, and file content for a text-based file. The cloud storage system searches the metadata of each file to determine its owner, geolocation, and date created and compares this information to the owner, geolocation, and date created information of the target file. The cloud storage system also searches the content data of each file to determine similarities in file content. This may include, for example, determining the amount of overlap of words in the file or determining the frequency of appearance of certain keywords in the searched file. Words appearing in the title, headings, or other prominent locations in the target file may be weighted more in the similarity search. The cloud storage system may also determine if the target file is named or found as a hyperlink in the searched file, or vice versa, which indicates similarity between the files. The cloud storage system may also determine if one or more websites have hyperlinks to both files. Various methods of determining content similarity between files are known and are contemplated as part of the similarity search described herein.

The cloud storage system assigns a score to each file, where the score represents the amount of similarity to the target file. The similarity score may be calculated in a number of ways. Independent similarity scores for each considered attribute (such as geolocation) are first calculated and normalized to a common median and standard deviation. For example, for geolocation, a searched file would get a score of 0 if it was accessed the furthest from the target document out of all searched documents in the sample, or a score of 1 if it was the closest. The normalized individual scores for the separate attributes are then aggregated into an overall similarity score based on one of the established aggregate distance measures, such as Euclidean distance or Cosine similarity.

The similarity score for a single attribute of the searched file is based on a similarity measure between the attribute of the target and searched files. Each individual score may be calculated in several ways. For example, the score for an attribute may be set to a predetermined value if an attribute of the searched file matches the same attribute of the target file. For example, the owner score of a searched file may be set from 0 to 1 if the owner of the searched file is the same as the owner of the target file, or the geolocation score of a searched file may be set from 0 to 1 if the geolocation of the searched file is the same as the geolocation of the target file. Other attributes, such as matching date created, date modified, and name of the file, may have similarity scores that are determined in this fashion. The score of an attribute may also be proportional or inversely proportional to the amount of difference between the attribute of the searched file and the attribute of the target file. For example, the geolocation score may be inversely proportional to the distance between the geolocation of the searched file and the geolocation of the target file. In another example, a date score may be inversely proportional to the time difference between the date the searched file was created or last modified and the date the target file was created or last modified. In yet another example, the collaborator score may be proportional to the number of collaborators that overlap between the searched file and the target file. The score may also be depend on the amount of textual or subject matter similarity in the file contents. Other methods of compiling the similarity score for an attribute are contemplated herein.

Once the individual similarity scores for each attribute are determined, the scores are aggregated to produce a single score for the search file. Aggregation, as mentioned above, may be accomplished using Euclidean distance, Cosine similarity, or a variety of other calculation methods. The aggregate score may be expressed as a numerical number, a percentage, or any other measure of similarity. Once the cloud storage system determines a score for each file it has searched, the cloud storage system presents a list of the searched files to the user. The list is ordered by the score of each file, indicating its similarity to the target file. The list is typically ordered such that the most similar documents are listed first, but the user may choose to order the list in another way.

A user may modify the “search for similar” command depicted in FIG. 7. For example, if a user selects the “Advanced Options” link 702f in user interface 700, the cloud storage system may direct the user's web browser to display user interface 800, illustrated in FIG. 8. User interface 800 provides options for the user to modify the parameters of the similarity search. User interface 800 may include an option for the user to change the target file used for the similarity search, shown on line 802. The user interface may display a list of attributes that are used to construct the similarity search, such as list 804. List 804 may include attributes found in the metadata or content data sections of the target file, such as name of file, owner, geolocation, date created, date last modified, collaborators, and file text. A user may select as many attributes as the user desires to form the similarity search. User interface 800 may also allow the user to set a hierarchy for the list of attributes such that certain attributes contribute a greater weight to the similarity score than other attributes. An example of such an option is depicted in line 806. User interface 800 may also allow the user to modify the search to only include files that match the target file in one or more attributes, rather than compile a list of similar documents. An example of this option is depicted in line 808. User interface 800 may include other options for modifying the “search for similar” command not illustrated, such as options for configuring how the results are displayed. After a user has made his or her customizations of the search, the user initiates the search by selecting the “Search” command button 810. The layout of user interfaces 700 and 800 are not limited to the layout depicted in FIGS. 7 and 8 but may encompass any reasonable layout for displaying the above-mentioned information and options.

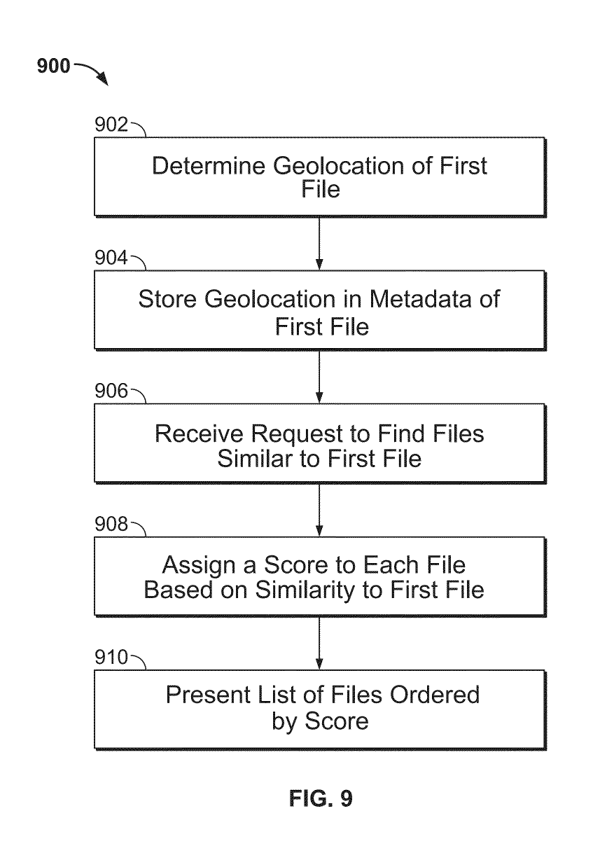

A cloud storage system collects geolocation information for files stored on its data store and provides users with the option to search for files similar to a target file, much like the “search for similar” command described above. A method for carrying out this searching for similar files is illustrated in FIG. 9. Method 900 includes determining, at a server, a geolocation for a file stored on the server, where the geolocation is based on the geographical location of a client device on which a user has edited the file. The method further includes storing the geolocation of the file in the metadata of the file and at a later time receiving from the user a request to search a plurality of other files stored on the server based on similarity to the file, where the similarity is based on the geolocation and a plurality of attributes of the file. The method further includes assigning a score to each file in the plurality of files, where the score is based on the similarity of each file to the geolocation and the plurality of attributes, and presenting to the user a list of the plurality of files ordered by score. The method may be performed on one or more servers that collectively form a cloud storage system.

Method 900 begins when a user, operating a client device, edits a file stored on a cloud storage system hosted by one or more servers, illustrated as 902. When the user makes any edits to the file, which includes creating and saving the file for the first time, the server obtains the geolocation of the file. The server obtains the geolocation of the file by obtaining the geolocation of the client device that the user has used to edit the file. Methods of obtaining a geolocation for a device have been described herein in relation to FIGS. 2 through 4. For example, the server may look up the IP address of the client device in a database that associates IP addresses with geolocations. The server may also determine geolocation from the Wi-Fi network that the client device is connected to, or may use the GPS functionality of the client device to obtain the geolocation. The server may ask the user for permission before obtaining the geolocation of the client device.

After the server has determined the geolocation of the file, the server stores the geolocation information in the metadata of the file, illustrated as 904. The metadata of the file stores a number of fields, or attributes, about the file. Geolocation is one of those attributes and the server writes the geolocation information into the metadata. The metadata may contain a revision history, where for each edit the user making the edit and the time and geolocation of the edit are recorded. The geolocation information may be associated with a label created by the user. For example, the user may specify that a certain Wi-Fi network or latitude and longitude coordinates correspond to the user's home. The geolocation information obtained from the client device is recognized by the server as falling under a user-defined label, such as “Home” or “Office.” The metadata of the file may store the label in addition to or alternatively to the geolocation information.

After the server has stored the geolocation in the metadata of the file, the server receives a request from the user to find other files similar to that file, illustrated as 906. For example, this request may be generated by a user selecting a command button on a user interface provided to the user by the server, such as “search for similar” command button 702e in user interface 700 of FIG. 7. The request includes information identifying the file used as the basis of the search, termed the target file. The similarity search is based on one or more attributes of the target file. There may be a default set of attributes that the server uses when the request is received, or the server may receive from the user a custom set of attributes to be used as the basis for the similarity search. The attributes are found in the metadata and content data of the target file and include the geolocation of the target file. Other attributes that may be used include the name of the file, owner of the file, the date created, the date last modified, the collaborators of the file, and the file content.

When the server receives the request, the server searches a set of files to determine the similarity of each file to the target file, illustrated as 908. The server may search all the files owned by the user, or may also include files shared with the user. A score is assigned to each file searched, where the score indicates the similarity of the file to the target file. The score is the aggregate of individual similarity scores between the target file and a searched file for each attribute, including geolocation. For example, the geolocation score may be based on whether the geolocation for both the searched file and the target file is the same. Individual attribute scores may also be proportional or inversely proportional to a measurable difference between an attribute of the searched file and the same attribute of the target file. For example, if the geolocation of the target file is “Home,” then the score of one file may be greater than the score of another file if the geolocation of the first file is “Office” while the geolocation of the second file is a city located in a foreign country, like “Paris.” The score of a file may be calculated and compiled in a number of different ways.

After the server assigns a score to each file that it has searched, the server presents the user with a list of the searched files, illustrated as 910. The list is ordered by score such that the most similar files are displayed first. The list may also display the score for each file. The user may be given options to reorder the list or to refine or redo the similarity search. In this manner, a cloud storage system provides a method for a user to search for files similar to a target file based on a set of attributes, where geolocation is one of the attributes.

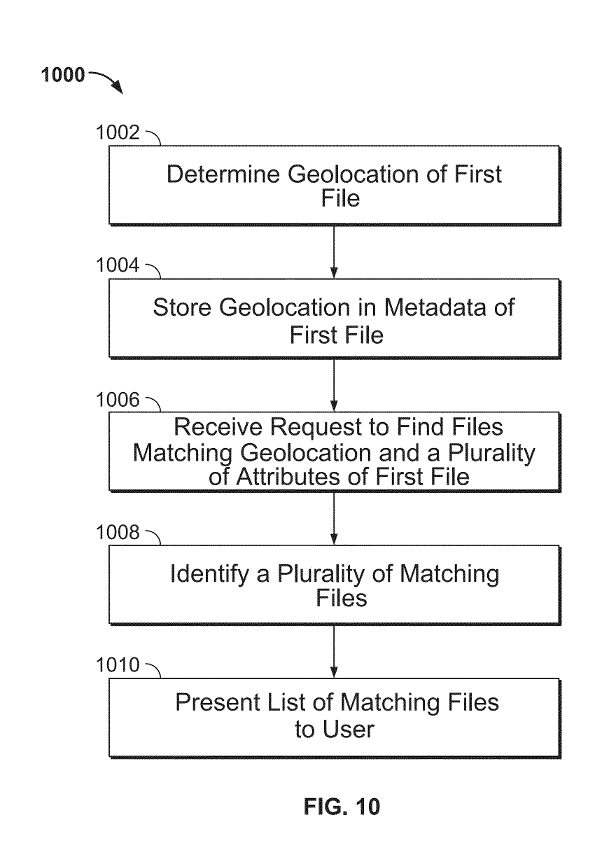

A cloud storage system may also provide users with the option to search for files that match one or more attributes of a target file, where one of the attributes is geolocation. A method for carrying out this search is illustrated in FIG. 10. Method 1000 includes determining, at the server, a geolocation for a file stored on the server, where the geolocation is based on the geographical location of a client device on which a user has edited the file. The method further includes storing the geolocation of the file in the metadata of the file. The method further includes receiving from the user a request to search a plurality of other files stored on the server for files matching the geolocation and a plurality of attributes of the file, termed the target file. The server identifies a plurality of matching files, where the geolocation of each matching file is the same as the geolocation of the target file, and the server presents to the user a list of the plurality of matching files.

Method 1000 begins when a user, operating a client device, edits a file stored on a cloud storage system hosted by one or more servers, illustrated as 1002. When the user makes any edits to the file, which includes creating and saving the file for the first time, the server obtains the geolocation of the file. The server obtains the geolocation of the file by obtaining the geolocation of the client device that the user has used to edit the file. Methods of obtaining a geolocation for a device have been described herein in relation to FIGS. 2 through 4. For example, the server may look up the IP address of the client device in a database that associates IP addresses with geolocations. The server may also determine geolocation from the Wi-Fi network that the client device is connected to, or may use the GPS functionality of the client device to obtain the geolocation. The server may ask the user for permission before obtaining the geolocation of the client device.

After the server has determined the geolocation of the file, the server stores the geolocation information in the metadata of the file, illustrated as 1004. The metadata of the file stores a number of fields, or attributes, about the file. Geolocation is one of those attributes and the server writes the geolocation information into the metadata. The metadata may contain a revision history, where for each edit the user making the edit and the time and geolocation of the edit are recorded. The geolocation information may be associated with a label created by the user. For example, the user may specify that a certain Wi-Fi network or latitude and longitude coordinates correspond to the user's home. The geolocation information obtained from the client device is recognized by the server as falling under a user-defined label, such as “Home” or “Office.” The metadata of the file may store the label in addition to or alternatively to the geolocation information.

After the server has stored the geolocation in the metadata of the file, the server receives a request from the user to find other files that match one or more attributes to the file, including geolocation. This is illustrated as 1006. For example, this request may be generated by a user utilizing a command option on a user interface provided to the user by the server, such as the “Match Attributes” option 808 in user interface 800 of FIG. 8. The request includes information identifying the file used as the basis of the search, termed the target file. The search is based on one or more attributes of the target file. There may be a default set of attributes that the server uses when the request is received, or the server may receive from the user a custom set of attributes to be used as the basis for the search. The attributes are found in the metadata and content data of the target file and include the geolocation of the target file. Other attributes that may be used include the name of the file, owner of the file, the date created, the date last modified, the collaborators of the file, and file content.

When the server receives the request, the server searches a set of files to find a set of matching files, where the set of attributes of each matching file matches the attributes of the target file, illustrated as 1008. The server may search all the files owned by the user, or may also include files shared with the user. The server compares the matching set of attributes of the target file with the attributes of each file searched. For example, if the matching set of attributes of the target file includes owner and geolocation, the server would compare the owner and geolocation information found in the metadata of each file with the owner and geolocation of the target file. If the owner and geolocation of the searched file matches the owner and geolocation of the target file, the server adds the searched file to a list of matching files. If the geolocation of the target file is associated with a label, e.g. “Home,” then files that have a geolocation associated with the same label may be considered a match. If the geolocation of the searched file is of a different scope than the geolocation of the target file, e.g. city-level versus street level, than the geolocation of the searched file may be considered a match if the geolocation of the target file encompasses the geolocation of the searched file. There may be a number of other rules or calculations the server may use to determine whether two attributes are considered a match.

After the server has searched, the server presents the user with a list of the matching files, illustrated as 1010. The list of matching files may be ordered by one or more of the matching attributes, or may be ordered in a manner specified by the user. The user may be given options to reorder the list or to refine or redo the search. In this manner, a cloud storage system provides a method for a user to search for files with attributes that match a set of attributes of a target file, where geolocation is one of the attributes.

It will be apparent to one of ordinary skill in the art that aspects of the systems and methods described herein may be implemented in many different forms of software, firmware, and hardware in the implementations illustrated in the figures. The actual software code or specialized control hardware used to implement aspects consistent with the principles of the systems and method described herein is not limiting. Thus, the operation and behavior of the aspects of the systems and methods were described without reference to the specific software code—it being understood that one of ordinary skill in the art would be able to design software and control hardware to implement the aspects based on the description herein.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

What is claimed is:

1. A method for searching for similar files stored on a server, the method comprising:
determining, at the server, a target geolocation for a target file stored on the server, wherein the target geolocation is based on a geographical location of a client device on which a user has edited the target file;
storing the target geolocation of the target file in metadata of the target file;
receiving from the user a request to search a plurality of files stored on the server based on similarity to the target file, wherein the similarity is based on the target geolocation and a plurality of attributes of the target file;
assigning a score to each file in the plurality of files, wherein the score is based on the similarity of each file to the target geolocation and the plurality of attributes; and
presenting to the user a list of the plurality of files ordered by score.

2. The method of claim 1, wherein the target geolocation is determined from an IP address of the client device.

3. The method of claim 1, wherein the target geolocation is determined from a Wi-Fi network utilized by the client device.

4. The method of claim 1, wherein the target geolocation is determined from GPS coordinates provided by the client device.

5. The method of claim 1, wherein a first attribute in the plurality of attributes is stored in the metadata of the target file.

6. The method of claim 1, wherein the score of a first file in the plurality of files comprises an aggregation of a plurality of individual scores, wherein a first individual score in the plurality of individual scores is based on similarity between a first geolocation stored in the first file and the target geolocation.

7. The method of claim 6, wherein a second individual score in the plurality of individual scores is based on similarity between a first attribute stored in the first file and the first attribute stored in the target file.

8. The method of claim 6, wherein the aggregation is selected from the group consisting of Euclidean distance and Cosine similarity.

9. The method of claim 1, wherein a first attribute in the list of attributes is weighted to contribute more to the score of each file in the plurality of files.

10. The method of claim 1, wherein the target geolocation is associated with a label.

11. The method of claim 1, wherein a first attribute in the plurality of attributes is selected from the group consisting of file name, owner, date created, date last modified, identity of collaborators, and file content.

12. A method for attribute-matching search of files stored on a server, the method comprising:
determining, at the server, a target geolocation for a target file stored on the server, wherein the target geolocation is based on a geographical location of a client device on which a user has edited the target file;
storing the target geolocation of the target file in metadata of the target file;
receiving from the user a request to search a plurality of files stored on the server for files matching the target geolocation and a plurality of attributes of the target file;
identifying a plurality of matching files from the plurality of files, wherein the geolocation of each matching file in the plurality of matching files is the same as the target geolocation and the plurality of attributes of each matching file is the same as the plurality of attributes of the target file; and
presenting to the user a list of the plurality of matching files.

13. The method of claim 12, wherein the target geolocation is determined from an IP address of the client device.

14. The method of claim 12, wherein the target geolocation is determined from a Wi-Fi network utilized by the client device.

15. The method of claim 12, wherein the target geolocation is determined from GPS coordinates provided by the client device.

16. The method of claim 12, wherein a first attribute in the plurality of attributes is stored in the metadata of the target file.

17. The method of claim 12, wherein the target geolocation is associated with a label.

18. The method of claim 12, wherein a first attribute in the plurality of attributes is selected from the group consisting of file name, owner, date created, date last modified, identity of collaborators, and file content.

19. A system for searching for similar files stored on a server, the system comprising:
a server, wherein the server is configured to:
communicate with a client device using a communication connection;
determine a target geolocation for a target file stored on the server, wherein the target geolocation is based on a geographical location of the client device on which a user has edited the target file;
store the target geolocation of the target file in metadata of the target file;
receive from the user a request to search a plurality of files stored on the server based on similarity to the target file, wherein the similarity is based on the target geolocation and a plurality of attributes of the target file;
assign a score to each file in the plurality of files, wherein the score is based on the similarity of each file to the target geolocation and the plurality of attributes; and
present to the user a list of the plurality of files ordered by score.

20. The system of claim 19, wherein the server further configured to:
identify a plurality of matching files from the plurality of files, wherein the geolocation of each matching file in the plurality of matching files is the same as the target geolocation and the plurality of attributes of each matching file is the same as the plurality of attributes of the target file; and
present to the user a list of the plurality of matching files.

21. The system of claim 19, wherein the target geolocation is determined from an IP address of the client device.

22. The system of claim 19, wherein the target geolocation is determined from a Wi-Fi network utilized by the client device.

23. The system of claim 19, wherein the target geolocation is determined from GPS coordinates provided by the client device.

24. The system of claim 19, wherein a first attribute in the plurality of attributes is stored in the metadata of the target file.

25. The system of claim 19, wherein the score of a first file in the plurality of files comprises an aggregation of a plurality of individual scores, wherein a first individual score in the plurality of individual scores is based on similarity between a first geolocation stored in the first file and the target geolocation.

26. The system of claim 25, wherein a second individual score in the plurality of individual scores is based on similarity between a first attribute stored in the first file and the first attribute stored in the target file.

27. The system of claim 25, wherein the aggregation is selected from the group consisting of Euclidean distance and Cosine similarity.

28. The system of claim 19, wherein a first attribute in the list of attributes is weighted to contribute more to the score of each file in the plurality of files.

29. The system of claim 19, wherein the target geolocation is associated with a label.

30. The system of claim 19, wherein a first attribute in the plurality of attributes is selected from the group consisting of file name, owner, date created, date last modified, identity of collaborators, and file content.

31. The system of claim 19, wherein the server is further configured to provide a user interface for the user to request to search the plurality of files stored on the server based on similarity to the target file.

32. The system of claim 31, wherein the user interface allows the user to select the plurality of attributes.

33. The system of claim 31, wherein the user interface allows a user to search for a plurality of matching files from the plurality of files, wherein the geolocation of each matching file in the plurality of matching files is the same as the target geolocation and the plurality of attributes of each matching file is the same as the plurality of attributes of the target file.
